(19) United States
(12) Patent Application Publication
(10) Pub. No.: US 2019/0088104 A1
(43) Pub. Date: Mar. 21, 2019

(54) Temperature and Motion Detection System for a Vehicle

(71) Applicants: Terri Crewe, Pflugerville, TX (US); Vincent Crewe, Pflugerville, TX (US); Donald Holbert, Galt, CA (US)

(72) Inventors: Terri Crewe, Pflugerville, TX (US); Vincent Crewe, Pflugerville, TX (US); Donald Holbert, Galt, CA (US)

(21) Appl. No.: 16/136,977

(22) Filed: Sep. 20, 2018

Related U.S. Application Data
(60) Provisional application No. 62/561,572, filed on Sep. 21, 2017.

(51) Int. Cl. G08B 21/22; B60R 21/015; B60Q 9/00; B60Q 5/00; G06K 9/00

(52) U.S. Cl. CPC G08B 21/22; B60R 21/01542; G06K 9/00838; B60Q 5/005; B60Q 9/00

(57) ABSTRACT

Temperature and motion detection system (TMDS) for detecting the presence of a living being, such as a baby or animal, left in a vehicle after the engine or electric motor has been shut off to help reduce harm or deaths from extreme temperatures. The TMDS, or parts thereof, include the ability to sense and differentiate ambient vehicle passenger compartment or cabin temperature from that of the living being (body heat) and also sense the presence or the motion of the living being. Upon comparing sensor inputs, or parameters related thereto, to one or more limits programmed or set for, or by, a control unit of the TMDS, the system activates alert subsystems in the vehicle, such as the alarm, horn, lights/flashers, lowering electric windows, unlocking doors, or the like to help decrease the occurrence of deaths when temperatures approach dangerously high or low values.

### CROSS-REFERENCE TO RELATED APPLICATIONS

This application claims the benefit of U.S. Provisional Application No. 62/561,572, filed Sep. 21, 2017.

### TECHNICAL FIELD

The present invention generally relates to detecting the presence of a living being, such as a child or animal, left or remaining in a vehicle and setting off warnings when the interior environment of the vehicle becomes harmful or threatening to life. More particularly, the present invention relates to monitoring and detecting environmental conditions in the passenger compartment or cabin of a vehicle after the engine or electric motor is shut off or fails, and activating vehicle alerts if a person or animal is left or remains in the vehicle when the ambient cabin environment becomes or approaches a life-threatening or harmful condition.

### BACKGROUND

A child's body heats up three to five times faster than an adult's does. See Prevent Child Deaths in Hot Cars, American Academy of Pediatrics (updated Jul. 18, 2018) (https://www.healthychildren.org/English/safety-prevention/on-the-go/Pages/Prevent-Child-Deaths-in-Hot-Cars.aspx). When left in a hot car, a child's major organs begin to shut down when his or her temperature reaches 104 degrees Fahrenheit (F), and a child can die when his or her temperature reaches 107 F. See id. Since 1998, 789 children have died due to pediatric vehicular heatstroke. See Heatstroke Deaths of Children in Vehicles, Jan Null, Department of Meteorology & Climate Science, San Jose State University (updated Sep. 12, 2018) (http://http://www.noheatstroke.org). An average of 37 children die in hot cars every year since 1998. See id.; A J Willingham, CNN (Jul. 20, 2018) (“More than 36 kids die in hot cars every year and July is usually the deadliest month.”) (https://www.cnn.com/2018/07/03/health/hot-car-deaths-child-charts-graphs-trnd/index.html). On a pleasant 75 F day, with the engine shut off, the inside of a parked car can reach 90 F in ten minutes. See Why hot cars can kill your child or pet, K. Hetter (Jul. 8, 2015) (http://www.cnn.com/2015/07/08/living/kids-pets-trapped-hot-cars-feat/index.html) (hereafter “Hot Cars”). Within 20 minutes, it can rise to 104 F. See id. On an 80 F day, a car can heat up to over 110 F in 25 minutes, and after an hour, it can hit 120 F. See Heatstroke Deaths of Children in Vehicles, Jan Null, Department of Meteorology & Climate Science, San Jose State University (2018) (http://www.noheatstroke.org/vehicle_heating.htm).

For these reasons and for other reasons described below, there is a need for improved systems, apparatus, and methods for detecting the presence of a person or animal left or remaining in a vehicle after the engine or motor shuts off or fails and environmental conditions arise in the passenger compartment or cabin of the vehicle that may present the possibility of harm or even death to such person or animal, as will become apparent to those skilled in the art upon reading and understanding this specification.

### SUMMARY

Embodiments of the present invention, referred to herein as a temperature and motion detection system (TMDS) are interfaced with or tied into a vehicle's existing alert subsystems. These embodiments include wiring, wiring harness(es) or bus(es), wireless components, or combinations thereof, that electrically couple or connect the TMDS into the vehicle's on-board diagnostic (OBD) connector and warning indicator light in the instrument panel. The wiring, wiring harness(es), or bus(es) can run and connect to each headlight, to the vehicle's alternator, taillights, emergency flashers, and turn signal lights. It also can run to a drive unit for each or all operable (electric) windows in the vehicle to lower them (e.g., halfway or all the way down) when necessary, and to each or all automatic door locks. The wiring, wiring harness(es), or bus(es) can further run to the vehicle's battery (e.g., through the OBD connector) to power the TMDS. The wiring, wiring harness(es), or bus(es) also can run to a backup battery that may be mounted in the trunk of the vehicle or elsewhere, alternatively, to power the TMDS in case the vehicle's battery fails. During normal operation, the backup battery will be charged from the vehicle's alternator. Moreover, the wiring, wiring harness(es), or bus(es), and the backup battery can be grounded appropriately in the rear or front of the vehicle to a vehicle ground (e.g., see vehicle ground 302 in FIG. 3).

Embodiments of the present invention, after the engine or electric motor has been shut off or fails, detect the presence of a living being left or remaining in the vehicle to help reduce harm or deaths from extreme temperatures. These embodiments of the TMDS include the ability to sense and differentiate the ambient temperature in the vehicle passenger compartment or cabin from that of the living being (body heat) and/or also sense the presence and/or motion of the living being in the vehicle compartment or cabin. As part of the TMDS, one or more sensors located in the vehicle and a control unit that interprets sensor(s) output are provided for this purpose. Upon comparing sensor(s) inputs. readings, or parameters to one or more limits programmed or set for or by the control unit, the system can activate the vehicle alert or warning subsystems, such as sounding an alarm(s), horn, turning on headlights, taillights, emergency flashers, turn signal lights, lowering electric windows, unlocking doors, or the like. The TMDS is expected to decrease deaths if a living being is left or remains in the vehicle without air conditioning or heat after the vehicle engine is shut off or fails when potentially harmful or deadly conditions exist.

Embodiments of the present invention, upon initiation and activation of the TMDS, after the vehicle engine is shut off, perform an initial scan using the sensor(s), which may be infrared (IR) sensor(s), to sense the passenger compartment environment or conditions. As a nonlimiting exemplary location, the sensor(s) may be mounted in or on the ceiling of the passenger compartment. The TMDS can be programmed to activate two minutes after the vehicle engine shuts off or fails, although other periods of time are contemplated and are included within the scope of the invention.

Embodiments of the present invention provide a TMDS that includes a controller, computer, processor, or the like (referred to hereafter as a control unit) that can be coupled or connected (e.g., via electrical wire harness(es), bus(es), or discrete wires, or wirelessly via Bluetooth, WiFi, or the like, or a combination of wired and wirelessly) with the vehicle's existing on-board diagnostic OBD system used in the industry, which vehicle manufacturers have provided since 1996. The current OBD system has been referred to as OBD-II or OBD2 since 1996 (all referred to hereafter as either OBD or OBD-II). OBD-II supports real-time telematics, such as for data on basic parameters like engine status, vehicle speed, RPM, fuel consumption, and more.

### BRIEF DESCRIPTION OF THE DRAWINGS

FIG. 1 is block diagram of a TMDS in accordance with embodiments of the invention.

FIGS. 2a and 2b illustrate a standard connector/pins and signal pinouts of a vehicle, respectively, used for reading diagnostic trouble codes (DTCs) and other signals carried by the pins related to vehicle performance, which may be used in the TMDS, in accordance with embodiments of the invention.

FIG. 3 is a schematic block diagram representation illustrating components of the TMDS in accordance with embodiments of the invention.

FIG. 4 is a schematic elevation view of the TMDS in a vehicle in accordance with embodiments of the invention.

### DETAILED DESCRIPTION OF THE INVENTION

This application claims the benefit of U.S. Provisional Application Ser. No. 62/561,572, filed Sep. 21, 2017, which is incorporated herein by reference in its entirety.

Various features and aspects of embodiments of the invention are now described with reference to the drawings. In the following description, for purposes of explanation, numerous specific details are set forth in order to provide a thorough understanding of these features and aspects. It will be evident, however, that embodiments of the invention may be implemented in numerous ways, including as methods, systems, devices, or apparatus, and that the various features or aspects of these embodiments may be practiced without all of these specific details or with more features and aspects. In some instances, structures and devices used in the related industry may be shown in block diagram form merely to describe these structures and devices concisely, and some may not be shown explicitly. Those skilled in the art will recognize that many modifications may be made to such features and aspects without departing from the scope of the present invention.

As used herein, the terms “component”, “module”, “system”, “unit,” or the like are intended to refer to a computer-related entity, hardware, software, a combination of hardware and software, software in execution, or other electrical or electronic entities. For example, a component may be, but is not limited to being, a processor, a process running on a processor, an object, an executable, a thread of execution, a program, a microcontroller or controller, a control unit, and/or a computer. By way of illustration, both code running on a computer and the computer itself can be a component. In addition, as used herein, component also may refer to non-computer entities, but are nevertheless part of the TMDS, some of which may be controlled by or electrically or wirelessly coupled or connected to a computer, such as wires, a wire harness(es), bus(es), wireless devices, relays, sensors, etc. One or more components further may reside within a process and/or thread of execution and a component may be localized on one computer and/or be distributed between two or more computers, microprocessors, controllers, or control units. Moreover, various features and aspects of embodiments of the invention will be presented in terms of systems that may include a number of components, modules, or the like. It is to be understood and appreciated that these systems may include additional components, modules, etc. and/or may not include all of the components, modules, etc. discussed in connection with the drawings. Also, a combination of these approaches or descriptors may be used herein.

The word “exemplary,” as used herein, means serving as a nonlimiting example, instance, or illustration of something. Any embodiment, feature, aspect, or design described herein as “exemplary” is not necessarily to be construed as preferred or advantageous over other embodiments, features, aspects, or designs unless specifically identified as such.

Embodiments of the invention are focused on living beings, particularly babies, children, the elderly, and animals. If these living beings, after the vehicle engine, electric motor (e.g., in an electric or hybrid vehicle) (all hereinafter referred to as engine or vehicle engine) is shut off or fails, are left or remain in a vehicle, they may become subjected to extreme conditions, such as dangerous or unsafe temperatures inside the vehicle. Typically, this is because the temperature outside the vehicle causes the temperature inside the vehicle to rise or drop to an unsafe level. The TMDS may be built into a vehicle by the vehicle manufacturer or provided as an option, or it may be added in an after-market installation. These embodiments, once activated and initiated after the engine shuts off or fails, detect the presence of life and the environmental conditions in the vehicle. Sensor(s) are provided for this purpose to sense cabin temperature, body heat, and for the presence/motion of a living being, whether the living being is stationary or moves in the passenger compartment. If dangerous condition limits are approached or reached, the TMDS will activate vehicle alert subsystems, which is expected to decrease deaths or harm to the living being.

Everything emits some thermal radiation, and the hotter something is, the more radiation it emits. Once activated and initiated, the TMDS performs an initial scan of the passenger compartment using the sensor(s) for that portion of the passenger compartment the particular sensor(s) is responsible for monitoring. The sensor(s) may be a passive proximity motion sensor(s), e.g., IR, pyroelectric, motion or presence detection sensor(s), or the like, referred to herein as “PIR.” When activated, such a sensor(s) detects the motion or stationary presence of the living being by sensing the IR radiation they emit in the cabin. The living being will exhibit a difference in the amount and thermal spectral features of IR radiation they emit compared to the rest of the cabin because the living being's temperature is different from the rest of the cabin unless the temperature and thermal spectral features of the living being and the vehicle cabin are the same. Thus, the sensor(s) will detect a difference in temperature and/or thermal spectral features, “signature,” “fingerprint,” image, representation, or thermal information between the two and provide such temperature information and/or thermal information to the control unit. The sensor(s), as nonlimiting examples, may be of the type that sense a region divided into two parts (halves) or four quadrants within the portion of the cabin it is assigned or set up to sense. The sensor(s) detect motion/presence (or change thereof), not average IR levels. Signals sensed for the portions or quadrants are wired or arranged to cancel each other out. If one portion provides more or less IR radiation than another portion, the output (e.g., a voltage or current level) will change, indicating the presence of the living being in the cabin.

The sensor(s) may be located or positioned in or near the vehicle cabin, depending on the vehicle or sensor(s) design or on necessity. For example, the sensor(s) can be mounted or located in or on the surface of the ceiling of the vehicle cabin or within the ceiling. In alternative embodiments, the sensor(s) may have a sensor probe(s) attached to or communicating with it (their) to provide the sensor(s) with the input temperature or thermal information it is (they are) set up to detect. The probe(s) may be positioned or mounted in or near the cabin, or on the surface of the ceiling, or within the ceiling of the vehicle cabin and communicate(s) with the sensor(s) wirelessly, by wired connection, by bus(es), or light- or fiber optic-guide to the sensor(s), if the sensor(s) is (are) positioned more remotely in the vehicle from the cabin. Such probe(s) or sensor(s) embedded within or inserted in the ceiling may still work as they are meant to, even if the material or structure making up the ceiling is physically in-between the probe(s) or sensor(s) and the open space of the vehicle cabin. This is because some IR radiation may still be detected and the material or structure may not absorb (or not absorb too much of) such wavelengths, depending on design of the material or structures, in certain embodiments. Moreover, in vehicles, such as a soft-top convertible or other vehicles in which a hard or hardtop roof is not included as part of the vehicle, or is taken off the vehicle, or in instances in which a vehicle's ceiling is inaccessible or unavailable for sensor(s) or probe(s) installation, the sensor(s) or probe(s) may instead or in addition be positioned in the A, B, or C pillars on the sides of the interior of the vehicle between vehicle windows, or behind or within a seat or a front seat, or a further back seat, or even in the dashboard or floor of the vehicle. Other locations are contemplated to be within the scope of the invention. Generally, one of ordinary skill in the art would know or know how to determine the best locations for such sensor(s) or probe(s) to perform its (their) tasks. Moreover, where and how to place and hide wires, a bus(es), or a harness(es) to connect the different components of the TMDS to the vehicle's OBD in embodiments that use such wires, bus(es), or harness(es) or use such wires, a bus(es), or a harness(es) in combination with wireless components, such as those described herein, as would be understood by those of ordinary skill in the art.

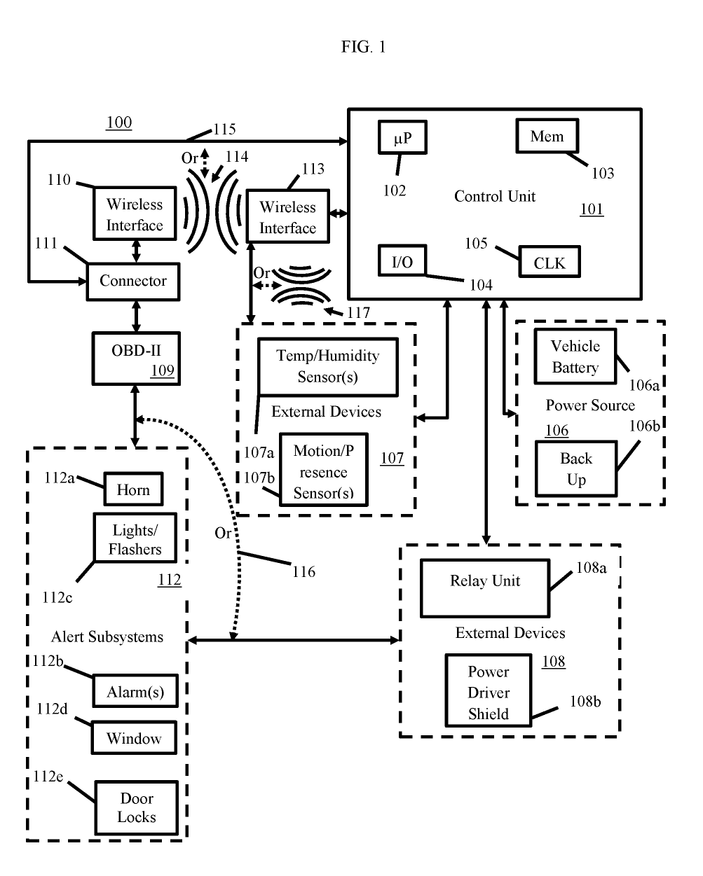

Turning now to the drawings, FIG. 1 shows a block diagram of a TMDS 100, in accordance with embodiments of the invention. The TMDS 100 includes a computer, microcontroller, or the like 101 (hereafter, control unit 101). The control unit 101 is a special purpose and dedicated programmable unit that is programmed to initialize, activate, and run the TMDS 100, which includes a microprocessor or processor (μP) 102, memory 103, input/output (I/O) 104, and clock (CLK) 105. The μP 102 executes code uploaded from and stored in the memory 103 to initiate, activate and run the TMDS 100 after the vehicle engine shuts off or fails. The memory 103 may be nonvolatile memory, such as firmware, EEPROM, flash, or the like. Volatile memory (not shown), such as RAM (e.g., DRAM) also may be included in the control unit 101 for use in storing the initiating, activating, and/or run code, and data or information for operation of the TMDS 100. Such volatile memory also may be used to store TMDS 100 runtime data, such as sensor(s) data when the TMDS 100 is operating and performing its functions after the engine is shut off or fails, as described below. Moreover, such code and/or data alternatively or additionally may be stored in a memory more closely associated with the μP 102, such as a cache memory (not shown) associated with and executed, or used for execution, by the μP 102. The code may be updated as described below.

As shown in FIG. 1, the TMDS 100 also includes a power source 106, which may be a battery 106a of the vehicle (i.e., the battery normally used to start the vehicle's engine) or a backup battery 106b (which may be mounted in the trunk of the vehicle), an external devices input unit 107, which includes temperature (or temperature and humidity) sensor(s) 107a to sense cabin temperature, and motion or presence IR sensor(s) 107b. Alternatively, the sensor(s) 107a and 107b may be in a combined unit, integrated sensor unit, or package 107a/107b that acts both to sample temperature and detect motion/presence. During operation of the TMDS 100, the temperature sensed by the sensor(s) 107a (or by the combined sensor(s) 107a/107b unit(s)) is compared to a temperature condition limit in the control unit 101 to determine if dangerous conditions are approaching or exist in the vehicle cabin, and if a living being is detected in the cabin, vehicle warning subsystems will be activated. For this purpose, the TMDS 100 further includes external devices output 108, which includes a relay unit(s) or module(s) 108a and power device shield unit(s) or module(s) 108b (or a combined relay unit(s) 108a/power device shield unit(s) 108b, which will be referred to hereafter as relay unit/power device shield 108a), to drive the vehicle's alerts subsystems 112, as will be described further below.

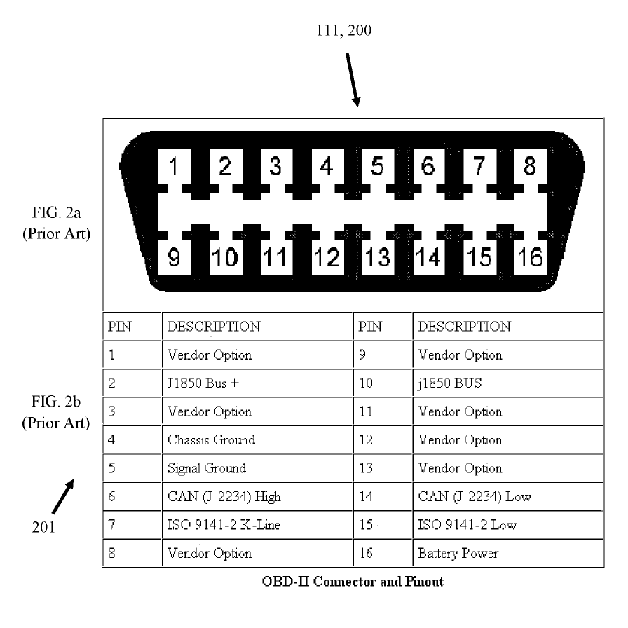

FIG. 1 also shows the TMDS 100 includes electrical connectivity to the vehicle's on-board diagnostic system OBD-II 109, which the vehicle manufacturers effectuate in hardware and software to comply with government-mandated specifications. The OBD-II 109 uses a standard 16-pin connector (known as the J1962 connector) (see FIGS. 2a and 2b) and various standard protocols for data, command, and address communications between electronic control units (ECUs) associated with various vehicle subsystems provided by manufacturers of the vehicle, such as the engine control unit, airbag system, infotainment system, etc., and between these subsystems and diagnostic or scan units (not shown), such as portable diagnostic units like the LAUNCH X431 Creader 3001 OBD2 Scanner, available from Multi-2 Technology Co., Ltd. or Amazon.com, Inc. These diagnostic units may be connected to the standard connector, as described below. The ECUs act as a distributed computer system for the vehicle.

Five signaling protocols have been permitted with the OBD-II interface. Most vehicles implement only one. Often it is possible to determine which protocol is employed from which pins are present on the standard connector. Some of the standard protocols and hardware used in vehicles include the CAN (Controller Area Network) Bus, CAN FD (flexible data rate), and CANopen. Typically, in vehicles, there are several CAN Buses, such as a high-speed CAN Bus, low speed CAN Bus, and others, that provide communications paths between the plurality of ECUs and through a connector 111 (shown in FIG. 2a as a connector 200), which is an example of the standard connector, to the diagnostic units, which can be connected to the connector 111 through a complementary connector (not shown) that also is standardized as part of OBD-II mandate.

The buses allow the ECUs to communicate signals with each other and with the diagnostic units without requiring a complex network of dedicated individual or point-to-point wiring between them. Technicians and mechanics can monitor the vehicle subsystems using the diagnostic units, which decode and analyze signals (that include standard diagnostic trouble (error) codes (DTCs) from the ECUs) communicated over the buses for indicating how well the various subsystems of the vehicle are performing and whether they may have malfunctioned or failed. The diagnostic units can be used to reset the DTCs, such those associated with engine and other vehicle subsystems' operations, and also to turn off related dashboard warning indicator lights. In accordance with embodiments of the invention, various of these features that already exist, including the connector 111, or which may be added to vehicles, can use software and hardware to allow engine and other vehicle subsystem statuses, including the temperature outside the vehicle and signals related to vehicle passenger compartment conditions, to be input to the TMDS 100 for use and analysis by the control unit 101 for activating the TDMS 100 and, thus, the vehicle alert subsystems 112, when necessary. Moreover, the inventive TMDS 100 represents an improvement over the existing ECUs and OBD-II systems currently employed in vehicles.

Regarding FIG. 1, the double-headed arrows (as indicated, for example, by reference numeral 115) shown between component blocks of the TMDS 100 indicate wire(s), bus(es), or harness(es) carry signals and/or power or both, and wavefronts (as schematically indicated, for example, by wavefronts 114 and 117) shown in FIG. 1 carry wireless signals or communications between wireless units or components of the TMDS 100. Further, referring to FIG. 1, the TMDS 100, in accordance with embodiments of the invention, electrically couples or connects to the connector 111 and the OBD-II 109 through a user-pluggable wireless interface device 110 having the complementary connector mentioned above. Power normally is supplied to the device 110 by the vehicle's battery 106a through the connector 111. In embodiments in which the battery 106a powers the TMDS 100, power may be split off the connector 111 or independently routed for connection to wires, a bus(es), or a harness(es) that go to the external devices input unit 107 to power the sensor(s) 107a and 107b (or the combined unit 107a/107b), the control unit 101, and a communications device 113 (described below) that connects to the control unit 101. The backup battery 106b similarly can supply power to any of these components or units of the TMDS 100 as well through wires, a bus(es), or a harness(es) if the battery 106a fails or if the battery 106a is not used for power to the TDMS 100.

The wireless interface device 110 includes Bluetooth, WiFi, or the like capability to provide wireless communications with the control unit 101 through a communications device 113 electrically coupled or connected to the control unit 101. In alternative embodiments, the control unit 101 may include its own Bluetooth, WiFi, or the like wireless receiver or transceiver on a printed circuit board or as an integrated circuit chip or system-on-chip of the control unit 101 itself for communications with and through the wireless interface device 110 to the OBD-II 109. In yet other embodiments, the control unit 101 is wired through discrete wires, a bus(es), or a harness(es) to the connector 111 or to other possible connections that may exist or could be added to electrically couple or connect to the OBD-II 109 or the ECUs, instead of using wireless communications (i.e., without the need for the wireless interface device 110 or the wireless communications device 113).

During its operation, the TMDS 100 monitors engine status through the device 110, and when the engine is shut off or fails, that data and information and other data and information is relayed to the TMDS 100. The wireless interface device 110 is treated as a “node” for the CAN Bus (and for other vehicle buses), which is electrically coupled or connected to the device 110 through or from the connector 111. The device 110 includes decoders to decode or read signals broadcasted or carried according to the various protocols on the corresponding various wires and/or bus(es) and/or harness(es) electrically coupled or connected to, or wirelessly coupled or connected, through the connector 111 to send them to the control unit 101. Alternatively, the decoders may be included as part of or in the control unit 101 as hardware, software, or a combination of both instead of or in addition to being in the device 110 (in which case the device 110 would or could just be a pass-through device to the control unit 101) for interpreting these signals carried by the various wires and/or bus(es) and/or harness(es), or wirelessly, through or from the connector 111. The rules to decode these signals may be proprietary to the various vehicle manufacturers, but they may be licensed or reversed engineered, which, although may be difficult, can be accomplished, or they may be provided by the vehicle manufacturers in the interest of saving lives. The rules also may be available because they are mandated to be disclosed by sovereignties that control the sale, use, and/or registration of vehicles located in their jurisdictions. Nevertheless, in some cases, most of the relevant parameters are standardized across the various manufacturers, such as in SAE J1939 for heavy-duty vehicles or SAE J1850.

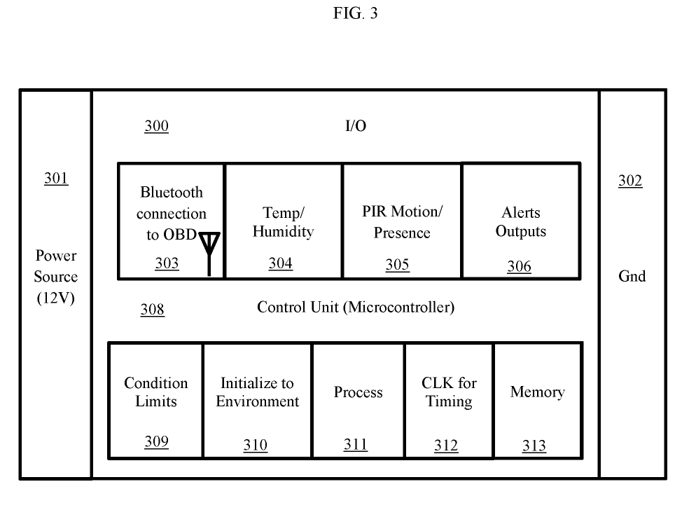

Referring to FIGS. 2a and 2b, a standard 16-pin connector 200 (same as the connector111) and its pinout 201 are shown for signals associated with the OBD-II 109. In the future, it is possible that the OBD-II protocol may change (or another protocol introduced) and/or some other connector may be used. These different protocols or different connectors are contemplated to be within the scope of the present invention. Some communications using the connector 200 are unidirectional and some are bidirectional, as would be understood by one of ordinary skill in the art. Pins 6 and 14 are designated for CAN Bus signals. Other pins are for signals that follow other standards, such as pins 2 and 10, and 7 and 15, for J1850, ISO 9141-2K, and ISO 9141-2 Low or L, respectively. J1850 also is used for diagnostics and data sharing applications in vehicles, and although its pins are present in the current OBD-II connector, it may be phased out in the future and its pins used by another one of the protocols mentioned herein or other protocols. ISO 9141-2 specifies requirements for setting up the exchange of digital information between the emission-related ECUs and the OBD-II scan or diagnostic tool. The K- and Low (L)-Lines of pins 7 and 15 are used for this. Pin 7 for the K-Line is a bidirectional single wire bus used for data transfer. Pin 15 for the L-Line, which is optional, may be used for stimulating an ECU, which remains at high-level thereafter. Pins 5 and 6 are reserved for vehicle chassis ground (e.g., the ground 302 in FIG. 3) and the battery/power, such as the battery 106a, respectively.

The pins and pinout shown in FIGS. 2a and 2b also include several vendor-optional or manufacturer discretionary pins. These are pins 1, 3, 8, 9, 11, 12, and 13. The vehicle manufacturers have the ability to customize the functions of these pins for different purposes, such as for other internal vehicle communications between ECUs through associated vehicle conductive wires, bus(es) and/or harness(es) (e.g., if new subsystems are added), or for diagnostics or other purposes, using the connector 111, 200.

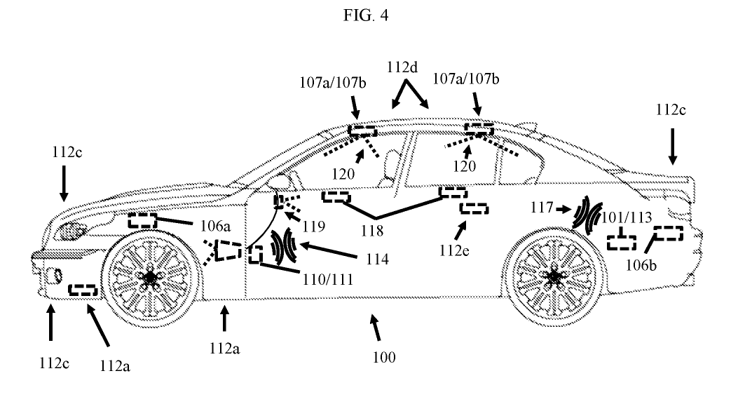

Referring again to FIG. 1 and to FIG. 4, the alert subsystems 112 may include any or all of the vehicle's horn 112a, alarm(s) 112b, lights (i.e., headlights, taillights, turn signal lights, and/or emergency flashers) 112c, electric power windows 112d, door locks 112e, or the like. The alert subsystems 112 may be installed by the vehicle manufacturers or some may be added as after- market installations.

Additional information about the use and operation of the relay unit/power shield device 108a, and its nonuse, is now provided. In accordance with exemplary embodiments of the invention, upon detection of the presence of a living being in the vehicle and that dangerous conditions (e.g., cabin temperature) are or are becoming present, the control unit 101 enters an alert mode of operation of the TMDS 100 and the control unit 101 sends signals to the relay unit/power shield device 108a, which activates and drives relays in the relay unit/power shield device 108a to allow high voltage to energize the vehicle's alert subsystems 112. In these embodiments, the TMDS 100 may be directly or indirectly wired through discrete wires, a bus(es), or a harness(es), either in combination with or not in combination with the wireless interface device 110 and the wireless communications device 113, to communicate with the ECUs associated with the alert subsystems 112 though the connector 111, 200 to allow power from the battery 106a or backup battery 106b to drive the alert subsystems 112 via the relay unit/power shield device 108a, such power passing through or not passing through the connector 111, 200 via wires, a bus(es), or a harness(es) added to the vehicle or already existing in or through the vehicle subsystems. Such wires, bus(es), and harness(es) are not shown for simplicity of the drawings, but whose routing, hiding from view in the vehicle, and operation would be understood by those of ordinary skill in the art.

Alternatively, in other exemplary embodiments, the TMDS 100 may communicate directly or indirectly via wires, bus(es), or harness(es), or in a combination of such wires, bus(es), or harness(es) with the wireless devices 110 and 113 described herein, through the connector 111, 200 with the ECUs associated with the alert subsystems 112 without the need for the relay unit/power shield device 108a. Such embodiments allow power to be directed from the battery 106a (or from the backup battery 106b) to drive the alert subsystems 112 through the connector 111, 200 or not through the connector 111, 200 using wires, bus(es), or harness(es) added to the vehicle or already existing in or through the vehicle subsystems. In yet other alternative exemplary embodiments, the TMDS 100, without communicating with the ECUs associated with the alert subsystems 112, may be electrically coupled or connected to the vehicle's alert subsystems 112 directly or indirectly, either through or not through the connector 111, 200 by wires, bus(es), or harness(es), or by wires, bus(es), or harness(es) in combination with the wireless devices 110 and 113 (if through the connector 111, 200), as described herein, and with or without using the relay unit/power device shield 108a, to allow power from the battery 106a or the backup battery 106b to drive the alert subsystems 112. In these latter embodiments, such power may or may not include passing through the connector 111, 200, but either way, also would pass through wires, a bus(es), or a harness(es) added to the vehicle or already existing in or through the vehicle subsystems. As described, in some of these embodiments, the vehicle's own ECUs associated with the alert subsystems 112 are bypassed and the TMDS 100 provides signals for direct or indirect driving of the alert subsystems 112. Bypassing these ECUs is fine because the control unit 101 can act effectively as an ECU and node for the alert subsystems 112 on the vehicle operations and communications systems. Those of skill in the art will understand that other exemplary embodiments of the invention can include other types of interfaces, couplings, connections, or combinations thereof than those explicitly described herein, all of which are contemplated for the same purpose of operating the TMDS 100 to protect living beings, and which are included within the scope of the present invention. For example, in other exemplary embodiments of the TMDS 100 the control unit 101 can communicate with the ECUs associated with the alert subsystems 112 and use the relay unit/power shield device 108a to provide power, as described herein, to the alert subsystems 112 from the battery 106a or the backup battery 106b via added and/or already existing wires, a bus(es), or a harness(es) in the vehicle without using the connector 111, 200 and without using the wireless devices 110 and 113. In addition, in embodiments in which the control unit 101 communicates with the existing ECUs associated with the alert subsystems 112 to activate these subsystems, the control unit 101 can send signals to request that power be supplied to these subsystems and these ECUs themselves, rather than the control unit 101, actually activate the provision of such power as described herein. Moreover, those of skill in the art would understand how the TMDS 100 described herein may be electrically coupled and connected to added or already existing connectors, wires, a bus(es), and/or a harness(es) in the vehicle.

In accordance with certain embodiments of the invention, in summary, if the control unit 101, upon detection of the presence of a living being in the vehicle and that dangerous conditions are or are becoming present, enters the alert mode of operation to activate the alert subsystems 112, depending on how the components, communications, couplings, connections, or combinations thereof of the TMDS 100 are implemented, as described herein, the control unit 101 can: (i) send low voltage (e.g., TTL) logic or control signals to drive higher voltage relays in the relay unit/power device shield unit 108a to drive the vehicle's alert subsystems 112 via the battery 106a or the backup battery 106b; or (ii) send signals to and through the connector 111 to pass through to the ECUs associated with the alert subsystems 112 to drive the alert subsystems 112 via the battery 106a or the backup battery 106b using added or already existing vehicle wires, a bus(es), or a harness(es) without needing the relay unit/power device shield unit 108a.

Examples of various components or modules of the TMDS 100 and how the TMDS 100 operates include the following, in accordance with embodiments of the invention:

1. The wireless interface device 110 may be an ELM327 available from Elm Electronics Inc. that connects to the connector 111, 200. The ELM327 is a programmed microcontroller capable of translating the OBD-II interface through the connect 111, 200. The ELM327 provides a simple interface that can be called, for example, by a UART with a handheld diagnostic tool or a computer program connected by USB, RS-232, Bluetooth, WiFi or smartphone, and that abstracts the low-level protocol of the vehicle's OBD-II 109. Bluetooth or WiFi wireless operation are preferred communications in embodiments of the present invention, but these other communications approaches are also contemplated and included within the scope of the present invention for communicating with the control unit 101 in operating the TMDS 100 for the purpose of protecting life in the vehicle from possible injury or death in an unsafe or approaching unsafe interior environment.

2. The control unit 101 may be or may be based on an Arduino—Programmable Micro Controller available from Adafruit Industries (amongst many others). The control unit 101 alternatively may be or may be based on a computer, a processor, or an application specific integrated circuit (ASIC). The control unit is a dedicated or special-purpose programmable computing unit for controlling and operating the TMDS 100, as described herein. The control unit 101 initializes all TMDS 100 units, components, or modules to the vehicle environment. After receiving an engine not in operation signal (because of engine shutoff or failure) via the connector 111 from the OBD-II 109 of the vehicle and the wireless interface device 110 (or via wired, a bus(es), or harness(es) connections that directly or indirectly electrically couple or connect to the wireless interface device 110, if not using the connector 111, 200, as described above), the control unit 101 initializes program cycling of the TMDS 100. The control unit 101 also loads preset conditions, such as the maximum or minimum temperature limits that, when approached or reached, will initiate activation of the vehicle alert subsystems 112 by the control unit 101. Under or approaching the dangerous conditions, the decision by the control unit 101 to activate the alert subsystems 112 will be based on these inputs and signals input to the control unit 101 from the sensor(s) 107a and 107b or combination unit 107a/107b. The control unit 101 also can render its operational status (e.g., active, needs updating, calibration or servicing, faulty, or the like) via display/LED(s) (not shown) that may be included on a board of the control unit 101 or otherwise included with the control unit 101 or in the TMDS 100, or rendered via activation of a warning indicator light 119.

3. The wireless communication device 113, may be, for example, an HCO5—Bluetooth Serial Pass-Through wireless serial communication device available from Guangzhou HC Information Technology Co., Ltd. or NewZoll. The HC-05 is a Bluetooth SPP (Serial Port Protocol) or Bluetooth serial interface module designed for a transparent wireless serial connection setup. Serial communications provide an easy way to interface the HC-05 with the control unit 101 for wireless communications, as schematically illustrated in FIG. 1 by wavefronts 114 and 117, between the wireless interface device 110 and the wireless communication device 113 to communicate with the control unit 101. The wireless link is initiated by the control unit 101 to the wireless interface device 110 via the wireless communications device 113. In other embodiments, the Bluetooth wireless communications device 113 instead may be provided by a WiFi interface device or module that is electrically coupled or connected (e.g., wired-, bus-, or harness-connected) to the control unit 101, which operates wirelessly to communicate with a WiFi version of the wireless interface device 110, such as a WiFi model of the ELM 327, via wireless wavefronts 114 and 117. Also, alternatively, the connection between the control unit 101 and the connector 111 may be wired, bused, or harnessed 115, as previously described, for the same purpose of communicating with the OBD-II 109 system, if signal decoding from the OBD-II 109 system is performed by the control unit 101 itself. With the wireless, wired, bused, or harnessed coupling or connection established, the engine status is passed to the control unit 101 for operation of the TMDS 100 and to perform its safety functions, as described herein.

4. The external device inputs 107, which includes the temperature (or temperature and humidity) sensor(s) 107a, may be a model 909-MOD-TC—Temperature & Humidity Sensor available from Mouser Electronics, a model MEMS Thermal Sensors D6T available from Omron Electronic Components LLC, or the like. The motion (or presence) IR sensor(s) 107b may be a PIR motion sensor, such as a model PIR325 pyroelectric IR sensor by Glolab Corporation or Mfr. Part#: LHI 878, Allied Stock#: 70219629 Dual-Element Pyroelectric

Detector by Allied Electronics, Inc., or the like. Because the D6T, such as the models D6T-44L-06 and D6T-8L-06 by Omron Electronic Components LLC, has high sensitivity using high-precision area temperature detection, it may also be the motion (or presence) IR sensor(s) 107b that detects the presence of a stationary person or animal, and thus the D6T models may be used as an example of the combined unit sensor(s) 107a/107b. The temperature sensor(s) 107a samples the vehicle interior temperature and the motion/presence sensor(s) 107b detects an identifiable change (e.g., because of the presence of a person or animal) in the surrounding environment, together which cover a heat source and motion/presence. These sensor(s) send temperature and detection/presence readings or related data to the control unit 101 for analysis through wires, a bus(es), or a harness(es) electrically coupled or connected to the control unit 101, or wirelessly (if, e.g., the sensor(s) 107a and 107b or the combined unit 107a/107b have their own wireless interfaces or interface devices integrated with them or provided for them (not shown)), as schematically illustrated by wavefront 117 in FIG. 1, using, for example, Bluetooth, WiFi, or the like, to the wireless communication device 113 interfaced to the control unit 101. In alternative embodiments, the control unit 101, instead of using the wireless communications device 113, may include a wireless transceiver itself on a printed circuit board of the control unit 101 or as part of an integrated circuit chip or system-on-chip of the control unit 101 for Bluetooth, WiFi, or the like communications, similar to that described above, with the sensor(s) 107a and 107b or with the wireless interface device 110 for operations of the TMDS 100.

5. The relay unit/power driver shield 108a of the external devices outputs 108 may be an HL-52S 2 channel relay module/power driver shield available from Amazon.com, Inc., made by and also available from SainSmart.com, although there are other manufacturers. The relay unit/power device shield 108a is used if the control unit 101 is directly or indirectly wired, bused, or harnessed to power the vehicle's alert subsystems 112 in case a dangerous temperature or the preset condition limit temperatures are approached or reached in the vehicle cabin with a living being present. The control unit 101 provides low voltage (e.g., TTL) logic signal to the relay unit/power driver shield 108a, as described above, that controls and allows a higher voltage and/or current to pass from the relay unit portion of the relay unit/power driver shield 108a to drive the alert subsystems 112. The relay unit 108a/power driver shield 108b isolates and protects the low- and high-voltage or current circuits from each other. The relay unit/power driver shield 108a thus permits a power supply to provide a stepped-up voltage or current using, for example, power MOSFETS (e.g., stepped-up from 12-volts) from the vehicle's battery system 106a or from a backup battery system 106b, either of which can provide main power to the TMDS 100, when the control unit 101 directly or indirectly activates the vehicle's alert subsystems 112 through wires, a bus(es), or a harness(es) that connect the relay unit portion of the relay unit/power shield device 108a to drive the alert subsystems 112.

Turning to further operations of the TDMS 100, in accordance with embodiments of the invention, once the vehicle's engine has been shut off or fails, whether or not the vehicle's key has been removed from the ignition switch or the vehicle's key fob has been taken out of range of its corresponding proximity sensor in the vehicle, the initiation and activation process of the TMDS 100 starts. The indicator light 119 in the instrument panel will illuminate to alert the vehicle operator or another occupant (if still in the vehicle with the engine shut off or if it fails) that the initiation and activation process is taking place for the TMDS 100 with the windows up (or in certain embodiments, with the windows “cracked” open or even with the windows more or completely open), whether or not the key is out of the ignition switch or the key fob is in the vehicle. The control unit 101 detects when the engine is shut off or fails by receiving a signal, such as a signal voltage or current going low, from the ODP-II 109 through a pin(s) of the connector 111 or as otherwise described herein by wire(s), bus(es), harness(es), or wirelessly from the ECU associated with engine operation. The control unit 101 then initiates and activates the TDMS 100 after an elapsed time of two minutes from engine shutoff or failure, using, for example, a hardware or software counter or timer in the control unit 101. Although two minutes is an exemplary time period, other time periods are contemplated within the scope of the invention (e.g., three minutes up to ten minutes or more). After the elapsed time, the control unit 101 receives and begins processing signals received from the sensor(s) 107a and 107b that carry temperature and living being detection/presence data. The sensor(s) 107b (or the combined unit of the sensor(s) 107a and 107(b)) detects motion or the presence of body heat or a body heat signature. The sensor(s) 107b, in certain embodiments, can measure body heat in four quadrants in the vehicle. If (i) a living being is present, as determined by initial and by later (as described below) scans 120 (schematically shown in FIG. 4) made by the sensor(s) 107a or 107b (or their combined unit 107a/107b); and (ii) if a dangerous environmental condition is approaching or is present in the vehicle cabin, such as approaching or reaching the preset cabin temperature limit, as determined from signals sent from the sensor(s) 107a or the combined sensor(s) 107a/107b to the control unit 101 from the scans, then the control unit 101 will activate the vehicle's existing alert subsystems 112, as described herein.

Depending on design, in accordance with embodiments of the invention, the TMDS 100 will activate the vehicle alert subsystems 112 based on transitioning temperatures or when a set temperature limit is reached in the vehicle cabin. As examples, if body heat/presence is detected (and continues to be detected) and the temperature in the cabin is transitioning from 75 F to 80 F and so on or has reached 85 F, or is transitioning from 50 F to 45 F and so on or has reached 40 F, and, if included in certain embodiments, the control unit 101 monitors signals from the vehicle subsystems that indicate outside temperature is high (e.g., 100 F) or low (e.g., 30 F), then the control unit 101 will fully activate the alert subsystems 112. The TDMS 100 will continue to scan the vehicle after every two minutes (or after other time periods, as described herein) while monitoring the interior cabin temperature (and the outside temperature in these certain embodiments).

In exemplary embodiments, if body heat is detected during the initial scan after two minutes from engine shut off or failure, the TMDS 100 will conduct a second scan of the vehicle cabin after another two-minute delay period while also monitoring the vehicle's cabin ambient temperature. Other delay times are contemplated for these delay time periods, for example, after three minutes up to after ten minutes or more. The actual scan times may be for example, for one-minute, two-minutes, although other scan times are contemplated, such as or anything in between one and two minutes or greater time periods, which may be based on the particular design of the TMDS 100 or its sensor(s) components, as described herein, considering the vehicle interior size, number of seats, number of rows of seats, and the like. For the duration of the second scan, if the TMDS 100 detects no body heat, it will deactivate the system and reset. If, however, body heat still remains positively detected for the duration of the second scan, the TMDS 100 will conduct a third scan after an additional two-minute delay period from the end of the second scan (other delay time periods are contemplated, such as greater than two minutes) while measuring the cabin temperature. Then, if the sensor(s) 107a and/or 107b (or their combined unit 107a/107b) scan and still positively detect body heat/motion/presence and provide signals to the control unit 101 directly or indirectly that the inside cabin temperature limit is approaching or reached (e.g., 90 F or 40 F)), the control unit 101 will activate the vehicle's alert subsystems 112, as described herein.

In accordance with embodiments of the invention, one of the purposes behind the monitoring actions described herein is to determine if the cabin temperature has transitioned not only to a harmful or dangerous level, but also from a harmful or dangerous level to a safer level between or during scans. The TMDS 100 will deactivate and/or turn off the alert subsystems 112 if safe levels are reached and maintained (i.e., the control unit 101 will receive a signal or sense a voltage or current from the sensor(s) 107a or the combined unit 107a/107b that conditions have become safe). Moreover, once the TMDS 100 is fully activated, if the ignition key is inserted into the ignition switch and turned to start the engine or the key fob is detected by the fob proximity sensor and the associated ignition push button is pressed or switch engaged to start the engine, the control unit 101 will receive a signal or sense a voltage or current that the engine is on through the connector 111 or as otherwise described herein via communications or connections with the vehicle's ECUs, and the TMDS 100 will be deactivated and/or the alert subsystems 112 will be deactivated by the control unit 101. Once deactivated the TMDS 100 will reset to its start/ready state for future scans.

If, however, the cabin temperature has not transitioned to a safer level between or during scans, the TMDS 100 will draw attention from nearby people that a living being is in the vehicle and cannot get out. If thereafter the engine is started or the windows are lowered or broken, or a door is unlocked and opened, and the temperature conditions in the vehicle cabin become or are becoming safer (e.g., change to safer values from the preset temperature condition limits), the TMDS100 will stop activating the alert subsystems 112 and reset to the start/ready state for future scans.

For the doors and windows, door and/or window sensor(s) 118 (shown in FIG. 4, which may be a combined door/window sensor(s)) can be used to detect if the door is opened and/or the window is broken. Such a sensor(s) 118 may be a motion or vibration sensor or a circuit carrying a voltage or current that is switched on or off (e.g., a completed or a broken circuit) if the door is opened and also a sensor(s) that detects vibrations (e.g., a piezoelectric crystal-based circuit) from the window being broken or opened, or a combination thereof, as would be understood by one of ordinary skill in the art. In accordance with embodiments of the invention, the sensor(s) 118 would be located in proximity to the door windows or near the door latch, for example, within the doors. A similar sensor(s) could be located near the front and rear windshields, such as in the dashboard near the front windshield or on a rear “shelf” area or side pillars near the front or rear windshields, to detect if the front or rear windshields have been broken for access to the living being in the cabin. The signals (or lack of signals condition in the case of a broken circuit) from the sensor(s) 118 would be carried by a wire(s), bus(es), or harness(es) directly or indirectly electrically coupled or connected to or through the connector 111 to the control unit 101, or directly or indirectly coupled or connected otherwise through a wire(s) a bus(es), harness(es), or wirelessly (or a combination thereof) to the control unit 101 without using the connector 111, 200, or wirelessly coupled or connected through the connector 111, 200 and the wireless interface unit 110 and the wireless communications unit 113 to control unit 101, as similarly described herein.

In accordance with embodiments of the invention, the size and number of seats and/or rows of seats in the vehicle can be used to determine the number needed and placement of the sensor(s) 107a and 107b or their combined unit 107a/107b in the vehicle. Smaller vehicles, for example, having one or two seats for seating ≤5 passengers, may have one sensor 107a and one sensor(s) 107b (or their combined unit 107a/107b, as described above) to monitor the front seat(s) (if there are no back seat(s)) or if there are only a front seat and a backseat for occupancy. Alternatively, there may be two pairs of these sensors 107a and 107b (or two combined units 107a/107b), one pair (or combined unit 107a/107b) for monitoring the front seat and the second pair (or combined unit) for monitoring the backseat. Larger vehicles, for example, seating >5 passengers, having multiple seats per row or multiple rows of seats can have one sensor pair (or combined unit) for each row of seats. If the vehicle is a seven-seater, two sensor(s) 107a and 107b (or their combined unit 107a/107b) may also be located between the second and third rows of seats, preferably in or on the ceiling of the vehicle. In other embodiments, the sensors may be located in or on the back(s) of the seats, near the top of the seat(s) or in or on the back(s) of the headrest(s). In a 12-15-foot passenger vehicle, for example, these sensor(s) 107a or 107b (or their combined unit 107a/107b) may be positioned between every other row of seats to enable or provide full protection throughout the cabin (or the length and width of the interior) of the vehicle. The maximum or minimum number of such a sensor(s) needed or used will be determined by consideration of their design constraints or tolerances and the vehicle's capabilities, operational and/or detection limitations, or of the TDMS 100, as would be understood by one of ordinary skill in the art.

It is contemplated that wide vehicles having wide rows of seats can have more than one pair of sensors or combined units per row for monitoring them. Generally, in certain embodiments, one pair of such a sensor(s) 107a or 107b (or one combined unit 107a/107b) can be set to detect in four quadrants and positioned to be centered on two rows of seats. If not set to the four-quadrant mode, they can be placed or centered on each row to detect body heat for that row only. As discussed above, the sensor(s) 107a and 107b (or the combined units 107a/107b) may be placed elsewhere, such as the backs of seats, the dashboard, the A, B, or C pillars, etc., depending on the size, type, and number of seats or rows in vehicle, the manufacturer's design of the vehicle, the capabilities of the TMDS 100, or as an aftermarket installer's choice based on the particular sensor(s) being used.

In accordance with embodiments of the invention, besides in the trunk, the backup battery 106b could be located in other parts of the vehicle, such as mounted under one of the seats, the dashboard, or in the engine compartment. The backup battery 106b can be charged or maintain a charge from the vehicle's alternator when the engine is running. In accordance with certain embodiments of the invention, a wired or bus(ed) or harness(ed) connection could be run to provide power from the vehicle's battery 106a (or power could be supplied by the vehicle's battery 106a through the connector 111) to drive the alert subsystems 112, the sensor(s) 107a and 107b or the combined unit 107a/107b, the backup battery 106b (via a switch if the vehicle battery 106a has too low a charge left or otherwise fails), the control unit 101, the relay unit/power device shield 108a, etc. of the TMDS 100, and to the vehicle's ground (e.g., the vehicle ground 302 shown in FIG. 3).

In accordance with embodiments of the invention, the TMDS 100 can be serviced by the vehicle manufacturer or vehicle service or repair shops by a mechanic or technician trained or certified for such servicing. The service may be included in the vehicle's scheduled or annual (or other time period) inspection or during preventative or periodic maintenance checks and services (PMCS), e.g., at a car dealer or garage, or if the TMDS 100 triggers a warning that an earlier servicing is needed. The TMDS 100 may be linked to turn on the vehicle's warning indicator light 119 in the instrument panel to signify that the TMDS 100 is malfunctioning or needs servicing or recalibrating akin to when it lights up for problems in other vehicle subsystems, such as the engine, fluids, brakes, airbag, etc. The mechanic or technician alternatively can inspect the display/LED(s) mentioned above showing the status of the control unit 101, if present, in certain embodiments of the invention, to see if the TMDS 100 has malfunctioned or needs servicing. Similarly, the indicator light 119 or the display/LEDs can indicate that the TMDS 100 system needs upgrading or updating. Upgrading or updating can include periodically upgrading or updating software for activating and running the TMDS 100 or for setting or resetting the temperature limits. The trained or certified mechanics or technicians will be able to perform such services by writing to or storing updated, upgraded, or new or changed parameter settings to the software or code stored in the memory 103 (e.g., in firmware). The backup battery 106b for the TMDS 100 may also be serviced annually (or another period of time) or need replacement, which may be recommended by the mechanic or technician, or which may be indicated by the warning indicator light 119 or the display/LED(s) mentioned above.

In accordance with embodiments of the invention, referring to FIG. 3, components of the TMDS 100 are illustrated in schematic block diagram form. These components are a combination of hardware and/or software components or modules that form or allow the TMDS 100 to function, and include an I/O interface 300 for the various input and output connections and signals that are sent to and from the TMDS 100 and the vehicle subsystems and connectors, as described herein. The components also include a control unit module 308 (e.g., for the control unit 101), and hardware and software modules for the power source 301 (i.e., for the vehicle battery 106a and/or the backup battery 106b), a vehicle ground 302, a wireless connection 303 (e.g., Bluetooth or WiFi for the devices 110 and 113) to the OBD-II 109, temperature/humidity module 304 (e.g., for the sensor(s) 107a), a motion/presence sensor(s) module 305 (e.g., for the sensor(s) 107b) (modules 304 and 305 can be combined for the combined sensor(s) unit 107a/107a), and an alerts outputs module 306 (e.g., for driving the vehicle alert subsystems 112, as described herein), a condition limits module 309 (e.g., for setting or updating the programmed temperature limits), an initialize to environment conditions module 310 (e.g., for initializing and activating the TMDS 100, as described herein), a process module 311 (e.g., for the processing operations, as described herein, of the control unit 101), a CLK for timing module 312 (e.g., for a software, hardware, or a combination software/hardware timer or counter for the control unit 101, such as for timing scans or the time delay between scans in the TMDS 100, as described herein), and a memory module 313 (e.g., for the memory 103 and what it stores or provides to or from the control unit 101 or the TMDS 100, as described herein). One of ordinary skill in the art would understand that more or less of these components or modules could be included in different embodiments of the invention and are contemplated to be so included.

In accordance with embodiments of the invention, FIG. 4 is a schematic elevation view of the TMDS 100 in a vehicle. FIG. 4 schematically shows components and connections of the TMDS 100, as described above, as they generally may be laid out, but, for simplicity of viewing, not all possible components of the TMDS 100 (compare FIG. 1) are shown and some components are shown as single blocks even though they may represent, in some cases, individual components or combined units, as described herein. Nevertheless, it should be understood that the components not shown could have been included to a greater or lesser extent, and are meant to be included in certain embodiments of the invention. Moreover, in FIG. 4, wires, bus(es), and/or harness(es) also are not shown for simplicity of viewing, and although the TMDS 100 is depicted as wireless-based in part (e.g., see wavefronts 114 and 117), wired-, bus-, or harness-coupled or connected embodiments could equally have been depicted, as described herein.

The specific embodiments described above are merely exemplary, and it should be understood that these embodiments may be susceptible to various modifications and alternative forms. Any structures, components, or process parameters, or sequences of steps described and/or illustrated herein are given by way of example only and can be varied as desired or needed. For example, for any steps illustrated and/or described herein that are shown or discussed in a particular order, these steps do not necessarily need to be performed in the order illustrated or discussed. The various exemplary structures, components, and/or methods described and/or illustrated herein may also omit one or more structures, components, and/or steps described or illustrated herein or may include additional structures, components, and/or method steps in addition to those disclosed. It should be further understood that the claims are not intended to be limited to the particular embodiments or forms disclosed herein, but rather to cover all modifications, equivalents, and alternatives falling within the spirit and scope of this disclosure.

What is claimed:

1. A vehicle system for detecting and alerting that a living being is in vehicle, comprising:
a control unit electrically coupled to an on-board diagnostic (OBD) system of the vehicle, the control unit programmable to detect engine shutoff or failure and to monitor and compare environmental conditions in the vehicle to preset environmental limits;
one or more sensors disposed in the vehicle to provide signals to the control unit related to the environmental conditions and whether a living being is present in the vehicle; and
wherein, if the living being is present and the environmental conditions approach or reach the preset environmental limits, the control unit activates alert subsystems of the vehicle.

2. The vehicle system of claim 1, wherein the control unit is wirelessly coupled to the OBD system.

3. The vehicle system of claim 1, wherein the control unit is coupled to the OBD via wires, a bus(es), or a harness(es).

4. The vehicle system of claim 1, wherein the control unit is coupled to the OBD via a combination of wireless devices with wires, a bus(es), or a harness(es).

5. The vehicle system of claim 1, wherein the one or more sensors comprise one or more passive infrared (IR) sensors, one or more pyroelectric sensors, and/or one or more motion/presence sensors.

6. The vehicle system of claim 1, further comprising a power source to power the system.

7. The vehicle system of claim 6, wherein power comprises a vehicle battery or a backup battery.

8. The vehicle system of claim 1, wherein the alert subsystems comprise a horn, lights, windows, door locks, or alarm.

9. The vehicle system of claim 1, wherein the alert subsystems are deactivated if the engine starts.

10. The vehicle system of claim 1, further comprising memory for storing program instructions executable by the control unit to activate the vehicle system, set the environmental limits, analyze signals received from the one or more sensors, and drive the alert subsystems.

11. The vehicle system of claim 1, wherein the vehicle system further comprises a relay unit/power device shield, and wherein the control unit is programmed to drive the relay unit/power device shield to activate the alert subsystems.

12. The vehicle system of claim 1, further comprising a display or LED(s) to display the status of the vehicle system.

13. The vehicle system of claim 1, wherein an indicator light of the vehicle is configured to display the status of the vehicle system.

14. The vehicle system of claim 1, further comprising a relay unit/power device shield electrically coupled to the control unit, wherein the control unit is configured to send signals to the relay unit/power device shield to provide power to activate the alert subsystems.

15. A method of alerting that a living being is present in a vehicle, comprising:
detecting vehicle engine shutoff or failure;
scanning for information related to temperature in a cabin of the vehicle;
scanning for motion/presence of a living being in the cabin;
determining if the information related to temperature approaches or reaches a limit; and
if the living being is in the cabin, activating an alert subsystem of the vehicle.

16. The method of claim 15, wherein activating the alert subsystem comprises activating a horn, lights, windows, door locks, or alarm of the vehicle.

17. The method of claim 15, further comprising, if the alert subsystem is activated, deactivating the alert subsystem if the vehicle engine is turned on.

18. A system for detecting a dangerous condition in a vehicle when a living being is in the vehicle, comprising:
one or more sensors disposed in the vehicle;
a control unit electrically coupled to the one or more sensors and an on-board diagnostic (OBD) system of the vehicle; and
wherein the control unit is programmable to:
detect engine shutoff or failure by signals received from the OBD system,
receive scan data from the one or more sensors related to temperature conditions in the vehicle and motion/presence data of a living being in the vehicle,
compare the scan data to preset environmental limits, and activate alert subsystems of the vehicle upon the preset environmental limits being approached or reached as indicated by comparison of the scan data to the preset environmental limits.

19. The system of claim 18, further comprising a relay unit/power device shield electrically coupled to the control unit, wherein the control unit is programmable to power the alert subsystems through relay unit/power device shield.

20. The system of claim 18, wherein the control unit is programmable to provide signals to ECUs associated with the alert subsystems to power the alert subsystems through vehicle wires, bus(es), or harness(es) from a vehicle battery or a backup battery.
